(19) United States
(12) Patent Application Publication
(10) Pub. No.: US 2012/0178611 A1
(43) Pub. Date: Jul. 12, 2012

(54) GLASS PASTE FOR PLASMA DISPLAY PANEL AND PLASMA DISPLAY PANEL

(76) Inventors: Hiroyuki Ajiki, Osaka (JP); Yukako Doi, Hyogo (JP); Yasuhiko Nakada, Osaka (JP); Takashi Furutani, Osaka (JP)

(21) Appl. No.: 13/395,220

(22) PCT Filed: Jul. 5, 2011
(86) PCT No.: PCT/JP2011/003824

§ 371 Date: Mar. 9, 2012

(30) Foreign Application Priority Data
Jul. 22, 2010 (JP) 2010-164570
Jul. 29, 2010 (JP) 2010-169999

(51) Int. Cl. C03C 14/00; B32B 5/16; B32B 3/26; C03C 3/00

(52) U.S. Cl. 501/32; 428/402

(57) ABSTRACT

A glass paste for a plasma display panel includes at least dielectric glass fine particles and hollow fine particles. The dielectric glass fine particle has a spherical shape or a scaly shape. Average particle diameter d₁ of the dielectric glass fine particles is at most 120 nm, and a largest particle diameter thereof is at most 400 nm. Average particle diameter d₂ of the hollow fine particles is at most 120 nm, and a largest particle diameter thereof is at most 400 nm.

### TECHNICAL FIELD

A technique disclosed herein relates to a plasma display panel used in, for example, a display device, and a glass paste for a plasma display panel.

### BACKGROUND ART

To ensure conductivity, silver electrodes are used as bus electrodes constituting display electrodes of a plasma display panel (hereinafter, called the PDP). Though low-melting glass mainly containing lead oxide is conventionally used as the material of a dielectric layer provided to cover the bus electrodes, the dielectric layers used in recent years include no lead component in view of environmental consciousness (for example, see Patent Literature 1).

It is demanded that capacitance of the dielectric layer be reduced to minimize reactive power so that power consumption in PDP can be lessened, that is to reduce the dielectric constant of the dielectric layer. According to a conventional technique employed to form the dielectric layer having a small dielectric constant, porous fine particles are deposited on a glass plate (for example, see Patent Literature 2).

### CITATION LIST

### Patent Literature

PTL 1: Unexamined Japanese Patent Publication No. 2003-128430

PTL 2: Unexamined Japanese Patent Publication No. 2009-259566

### SUMMARY OF THE INVENTION

A glass paste for a plasma display panel includes at least dielectric glass fine particles and hollow fine particles. The dielectric glass fine particle has a spherical shape or a scaly shape. Average particle diameter d₁ of the dielectric glass fine particles is at most 120 nm, and a largest particle diameter thereof is at most 400 nm. Average particle diameter d₂ of the hollow fine particles is at most 120 nm, and a largest particle diameter thereof is at most 400 nm.

### BRIEF DESCRIPTION OF DRAWINGS

FIG. 1 is a perspective view illustrating a structure of a PDP according to an exemplary embodiment.

FIG. 2 is a schematic illustration of a front plate in cross section according to the exemplary embodiment.

FIG. 3 is a schematic illustration of a dielectric glass slurry according to the exemplary embodiment.

FIG. 4 is a schematic illustration of a hollow fine particle slurry according to the exemplary embodiment.

FIG. 5 is a front view of a hollow fine particle having a spherical shape according to the exemplary embodiment.

FIG. 6 is a sectional view of FIG. 5 cut along 6-6.

FIG. 7 is a perspective view of a hollow fine particle having a hexahedral shape according to the exemplary embodiment.

FIG. 8 is a sectional view of FIG. 7 cut along a long-and-short-dashed line.

FIG. 9 is a schematic illustration of a dielectric paste according to the exemplary embodiment.

### DESCRIPTION OF EMBODIMENTS

1. Structure of PDP 1

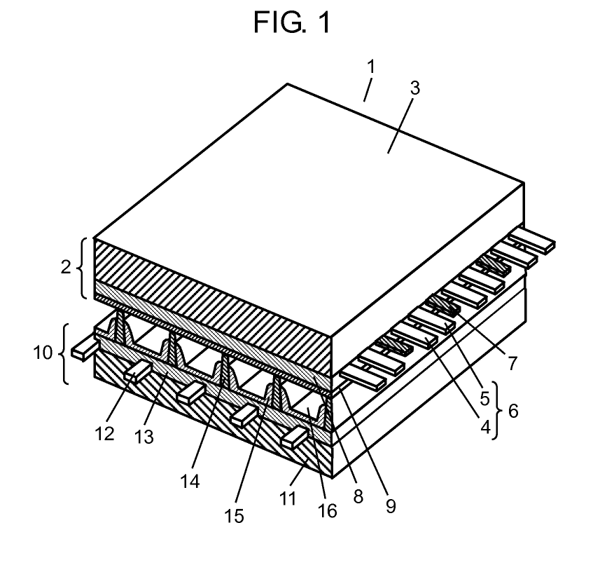

PDP 1 according to an exemplary embodiment of the present invention is an alternating current (AC) surface discharge type PDP. As illustrated in FIG. 1, PDP 1 has a structure where front plate 2 including front glass substrate 3 and rear plate 10 including rear glass substrate 11 are disposed facing each other. Outer peripheral portions of front plate 2 and rear plate 10 are air-tightly sealed to each other with a sealing member made of, for example, glass frit. A discharge gas containing xenon (Xe) is enclosed in discharge space 16 inside sealed PDP 1 under a pressure in the range of 55 kPa to 80 kPa.

A plurality of pairs of strip-shaped display electrodes 6 each including scan electrode 4 and sustain electrode 5 and a plurality of light shielding layers 7 are provided on front glass substrate 3 in parallel with one another. Scan electrode 4 includes black electrode 4a and white electrode 4b formed on black electrode 4a. Sustain electrode 5 includes black electrode 5a and white electrode 5b formed on black electrode 5a. Dielectric layer 8 is formed on front glass substrate 3 so as to cover display electrodes 6 and light shielding layers 7. Dielectric layer 8 functions as a capacitor. Further, protective layer 9 made of, for example, magnesium oxide (MgO) is formed on a surface of dielectric layer 8.

A plurality of strip-shaped address electrodes 12 are formed on rear glass substrate 11 in parallel with one another in a direction orthogonal to display electrodes 6. Address electrodes 12 are coated with insulating layer 13. Barrier ribs 14 each having a predetermined height and dividing discharge space 16 are formed on insulating layer 13 provided between address electrodes 12. Phosphor layer 15 to emit red light, phosphor layer 15 to emit blue light, and phosphor layer 15 to emit green light under ultraviolet rays are sequentially formed between barrier ribs 14.

A discharge cell is formed at a position where display electrode 6 and address electrode 12 intersect with each other. The discharge cell having red-emitting phosphor layer 15, discharge cell having blue-emitting phosphor layer 15, and discharge cell having green-emitting phosphor layer 15 constitute a color display pixel.

2. Production Method of PDP 1

2-1. Production Method of Front Plate 2

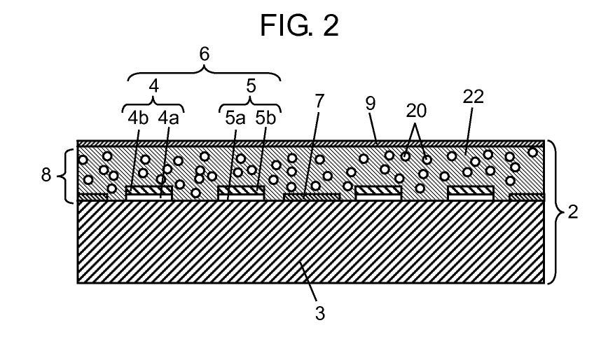

As illustrated in FIG. 2, scan electrodes 4, sustain electrodes 5, and black stripes 7 are formed on front glass substrate 3 by photolithography. Scan electrode 4 and sustain electrode 5 respectively have white electrodes 4b and 5b including silver (Ag) for ensuring conductivity. Further, scan electrode 4 and sustain electrode 5 respectively have black electrodes 4a and 5a including a black pigment to improve the contrast of an image display screen. White electrode 4b is laminated on black electrode 4a, and white electrode 5b is laminated on black electrode 5a.

A material of black electrodes 4a and 5a is a black paste including a black pigment for ensuring a degree of blackness, a glass frit for binding a black pigment, a photosensitive resin, and a solvent. First, the black paste is spread on front glass substrate 3 by, for example, screen printing. Next, the solvent in the black paste is removed therefrom in a baking oven. Then, the black paste is exposed to light via a photo mask formed in a predetermined pattern.

A material of white electrodes 4b and 5b is a white paste including silver (Ag), a glass frit for binding silver, a photosensitive resin, and a solvent. First, the white paste is applied on front glass substrate 3 where the black paste is already applied by, for example, screen printing. Next, the solvent in the white paste is removed therefrom in the baking oven. Then, the white paste is exposed to light via a photo mask formed in a predetermined pattern.

Then, the black paste and the white paste are developed so that a black electrode pattern and a white electrode pattern are formed. Lastly, the black electrode pattern and the white electrode pattern are fired at a predetermined temperature in a baking oven so that the photosensitive resin in the black electrode pattern and the photosensitive resin in the white electrode pattern are removed therefrom. Further, the glass frit in the black electrode pattern melts, and the molten glass frit starts to vitrify again after the firing. Further, the glass frit in the white electrode pattern melts, and the molten glass frit starts to vitrify again after the firing. As a result of these steps, black electrodes 4a and 5a and white electrodes 4b and 5b are formed.

Black stripes 7 are formed in a manner similar to black electrodes 4a and 5a. Black stripes 7 may be formed at the same time as black electrodes 4a and 5a. In place of screen printing employed to apply the black electrode paste and the white electrode paste, sputtering or vapor deposition, for example, may be employed.

Next, dielectric layer 8 which covers scan electrodes 4, sustain electrodes 5, and light shielding layers 7 is formed. Dielectric layer 8 will be described in detail later.

Protective layer 9 made of, for example, magnesium oxide (MgO) is formed on dielectric layer 8. An EB (Electron Beam) vapor deposition apparatus, for example, is used to form protective layer 9. A material of protective layer 9 is a pellet made of single crystal MgO. The pellet may further contain aluminum (Al) or silicon (Si) as impurities.

First, electron beams are directed to the pellet placed in a deposition chamber of the EB vapor deposition apparatus. The pellet subjected to the energy of electron beams is evaporated. The evaporated MgO is adhered to dielectric layer 8 placed in the deposition chamber. The film thickness of MgO is adjusted to stay in a predefined range by tuning an electron beam intensity and a pressure in the deposition chamber.

Other examples of protective layer 9 are a mixed film containing calcium oxide (CaO) in addition to MgO, a film containing a metal oxide such as strontium oxide (SrO), barium oxide (BaO), or aluminum oxide (Al₂O₃), or a film containing a plurality of different metal oxides.

As a result of these steps, front plate 2 having required structural elements on front glass substrate 3 is completed.

2-2. Production Method of Rear Plate 10

As illustrated in FIG. 1, address electrodes 12, insulating layer 13, barrier ribs 14, and phosphor layers 15 are formed on rear glass substrate 11.

First, address electrodes 12 are formed on rear glass substrate 11 by photolithography. A material of address electrode 12 is an address electrode paste including silver (Ag) for ensuring conductivity, a glass frit for binding silver, a photosensitive resin, and a solvent. First, the address electrode paste is applied in a predetermined thickness on rear glass substrate 11 by, for example, screen printing. Next, the solvent in the address electrode paste is removed therefrom in the baking oven. Then, the address electrode paste is exposed to light via a photo mask formed in a predetermined pattern. Then, the address electrode paste is developed so that an address electrode pattern is formed. Lastly, the address electrode pattern is fired at a predetermined temperature in the baking oven so that the photosensitive resin in the address electrode pattern is removed therefrom. Further, the glass frit in the address electrode pattern melts, and the molten glass frit starts to vitrify again after the firing. As a result of these steps, address electrodes 12 are formed. In place of screen printing employed to apply the address electrode paste, sputtering or vapor deposition, for example, may be employed.

Next, insulating layer 13 is formed. A material of insulating layer 13 is an insulating paste including a dielectric glass frit, a resin, and a solvent. First, the insulating paste is applied by, for example, screen printing on rear glass substrate 11 in a predetermined thickness so as to cover address electrodes 12 formed thereon. Next, the solvent in the insulating paste is removed therefrom in the baking oven. Lastly, the insulating paste is fired at a predetermined temperature in the baking oven so that the resin in insulating paste is removed therefrom. Further, the dielectric glass frit melts, and the molten dielectric glass frit starts to vitrify again after the firing. As a result of these steps, insulating layer 13 is formed. In place of screen printing employed to apply the insulating paste, die coating or spin coating, for example, may be employed. Instead of using the insulating paste, a film used as dielectric layer 13 may be formed by, for example, CVD (Chemical Vapor Deposition).

Next, barrier ribs 14 are formed by photolithography. A material of barrier rib 14 is a barrier rib paste including a filler, a glass frit for binding a filler, a photosensitive resin, and a solvent. First, the barrier rib paste is applied by die coating or the like on insulating layer 13 in a predetermined thickness. Next, the solvent in the barrier rib paste is removed therefrom in the baking oven. Then, the barrier rib paste is exposed to light via a photo mask formed in a predetermined pattern. Then, the barrier rib paste is developed so that a barrier rib pattern is formed. Lastly, the barrier rib pattern is fired at a predetermined temperature in the baking oven so that the photosensitive resin in the barrier rib pattern is removed therefrom. Further, the glass frit in the barrier rib pattern melts, and the molten glass frit starts to vitrify again after the firing. As a result of these steps, barrier ribs 14 are formed. The photolithography may be replaced with sandblasting or the like.

Next, phosphor layers 15 are formed. A material of phosphor layer 15 is a phosphor paste including phosphor particles, a binder, and a solvent. First, the phosphor paste is applied in a predetermined thickness by dispensing or the like on insulating layer 13 between adjacent barrier ribs 14 and side surfaces of barrier ribs 14. Next, the solvent in the phosphor paste is removed therefrom in the baking oven. Lastly, the phosphor paste is fired at a predetermined temperature in the baking oven so that the resin in phosphor paste is removed therefrom. As a result of these steps, phosphor layers 15 are formed. The dispensing may be replaced with screen printing or the like.

As a result of these steps, rear plate 10 having required structural elements on rear glass substrate 11 is completed.

2-3. Assembling Method of Front Plate 2 and Rear Plate 10

First, a sealing member (not illustrated in the drawings) is formed in a peripheral portion of rear plate 10 by dispensing. A material of the sealing member (not illustrated in the drawings) is a sealing paste including a glass frit, a binder, and a solvent. Next, the solvent in the sealing paste is removed therefrom in the baking oven. Then, front plate 2 and rear plate 10 are disposed facing each other so that display electrodes 6 and address electrodes 12 are orthogonal to each other. Then, peripheral portions of front plate 2 and rear plate 10 are sealed to each other with a glass frit. Lastly, a discharge gas containing Xe by at least 15 vol. % to at most 30 vol. % is enclosed in discharge space 16, to complete PDP 1.

3. Detail of Dielectric Layer 8

Dielectric layer 8 is demanded to meet such requirements as a low dielectric constant, a high breakdown voltage, and a high light transmissivity. Whether these requirements can be met greatly relies on the structure of dielectric layer 8. As illustrated in FIG. 2, dielectric layer 8 according to this exemplary embodiment includes hollow fine particles 20 having a hollowed-out inside. For example, dielectric layer 8 may include hollow fine particles 20 and dielectric glass layer 22 which is a glass layer. Hollow fine particles 20 are dispersed in dielectric layer 8. Hollow fine particles 20 are preferably dispersed uniformly in dielectric layer 8. For ease of explanation, the number of hollow fine particles 20 and particle sizes thereof illustrated in FIG. 2 are different to those of an actual product.

As described later, whether hollow fine particles 20 are uniformly dispersed in dielectric layer 8 are determined by variously different measuring methods. For example, there is a method of measuring a visible light transmissivity of front plate 2. Unless hollow fine particles 20 are dispersed uniformly in dielectric layer 8, the visible light transmissivity becomes lower. Other than the given example, there is a method of measuring a haze value of front plate 2. Unless hollow fine particles 20 are dispersed uniformly in dielectric layer 8, the haze value becomes higher.

Conventionally, the dielectric glass contains lead oxide by at least 20 wt. % so that firing can be performed at approximately 450° C. to 600° C. However, the dielectric glass according to this exemplary embodiment contains no lead oxide in view of environmental consciousness. In other words, dielectric layer 8 contains no lead oxide.

3-1. Production of Dielectric Paste 50

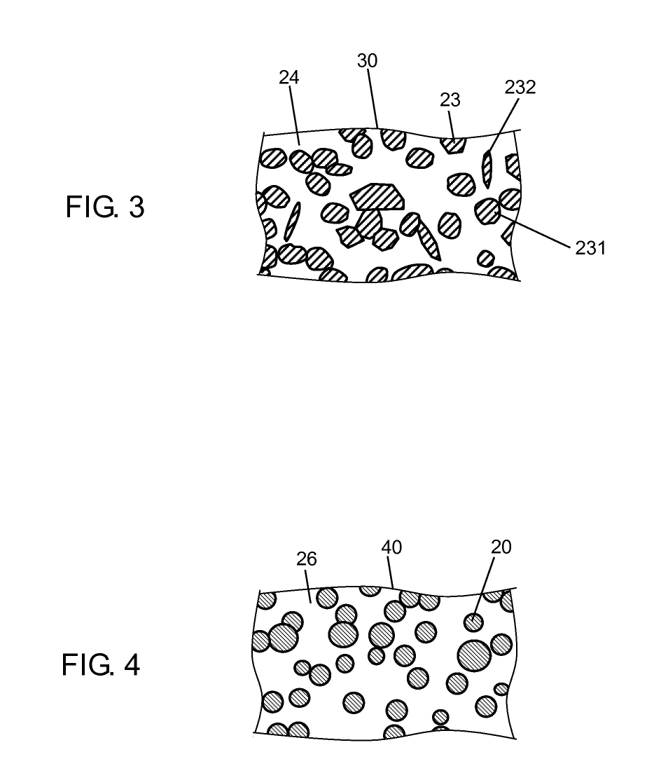

As illustrated in FIGS. 3, 4, and 9, dielectric paste 50 includes dielectric glass slurry 30 having dielectric glass fine particles 23 dispersed therein, hollow fine particle slurry 40 having hollow fine particles 20 dispersed therein, and a vehicle.

3-2. Dielectric Glass Slurry 30

As illustrated in FIGS. 3, dielectric glass fine particles 23 by 10 wt. % to 65 wt. % and solvent 24 by 35 wt. % to 90 wt. % are mixedly dispersed in dielectric glass slurry 30. For example, dielectric glass fine particles 23 include diboron trioxide (B₂O₃), silicon dioxide (SiO₂), and an alkali-metal oxide such as potassium oxide (K₂O), lithium oxide (Li₂O), or sodium oxide (Na₂O). Solvent 24 is, for example, an alcohol-based solvent, a glycol-based solvent, or an aqueous solvent.

First, a dielectric glass material including the mentioned constituent ingredients is ground by a wet jet mill or a ball mill so that average particle diameter d₁ is at least 10 nm to at most 120 nm and a largest particle diameter is at most 400 nm. As a result, dielectric glass fine particles 23 are obtained. According to this exemplary embodiment, an inscribed sphere diameter is used to define the particle diameter of dielectric glass fine particle 23. The inscribed sphere diameter is a largest diameter of dielectric glass fine particle 23 in which the surface of a sphere hypothetically inserted in dielectric glass fine particle 23 can be inscribed. Dielectric glass fine particle 23 can be formed in various shapes, examples of which are; dielectric glass fine particle 231 having a substantially spherical shape, and dielectric glass fine particle 232 having a scaly shape.

It is more preferable that average particle diameter d₁ of dielectric glass fine particle 23 be at least 10 nm to at most 100 nm, and a largest particle diameter thereof be at most 400 nm. The particle diameter values are measured by a SEM (Secondary Electro emission Microscopy) apparatus. To produce a dielectric glass slurry in which hollow fine particles 20 are uniformly dispersed, it is preferable to regulate the particle diameters of dielectric glass fine particles 23. In the case where average particle diameter d₁ of dielectric glass fine particles 23 exceeds 100 nm and the largest particle diameter thereof exceeds 400 nm, hollow fine particles 20 are disproportionately distributed in dielectric layer 8 formed later. Such an unfavorable event occurs because hollow fine particles 20 are distributed on the circumferences of dielectric glass fine particles 23 when dielectric glass slurry 30 is mixed with hollow fine particle slurry 40 described later, and the disproportionate distribution of the particles is sustained even after the firing. In dielectric layer 8 having such a problem, visible light entering dielectric layer 8 possibly scatters therein, deteriorating the visible light transmissivity. Therefore, it is more preferable that average particle diameter d₁ of dielectric glass fine particles 23 be at least 10 nm to at most 100 nm, and the largest particle diameter thereof be at most 400 nm.

Dielectric glass slurry 30 may further contain a lubricant or a dispersant. Dielectric glass slurry 30 further containing a lubricant or a dispersant has better dispersibility.

3-3. Hollow Fine Particle Slurry 40

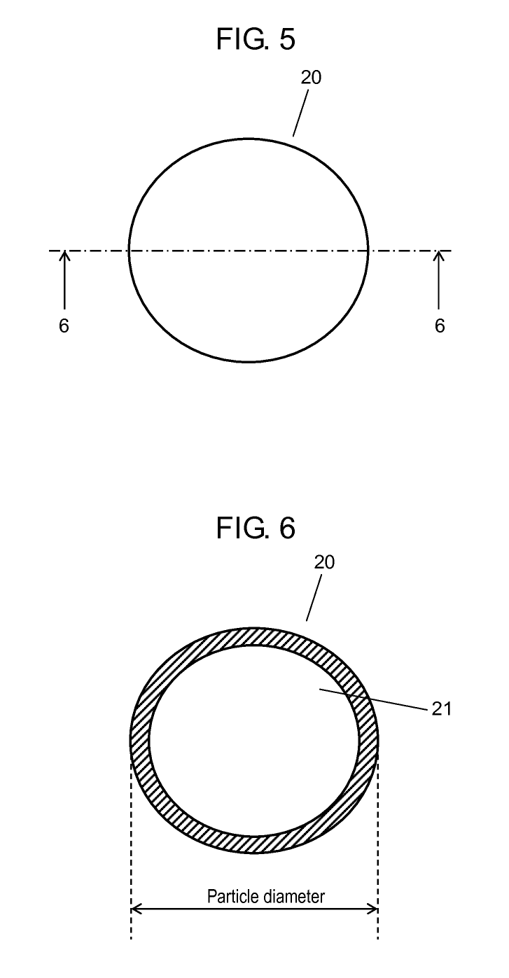

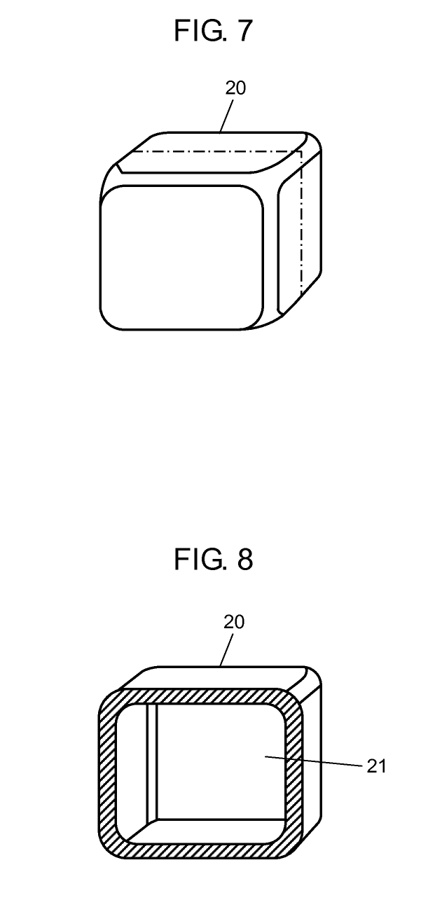

As illustrated in FIG. 4, hollow fine particles 20 by 1 wt. %-20 wt. % and solvent 26 by 80 wt. %-99 wt. % are mixedly dispersed in hollow fine particle slurry 40. A principal constituent of hollow fine particle 20 is, for example, silicon dioxide (SiO₂). Other examples of the principal ingredient are aluminum oxide (Al₂O₃), zinc oxide (ZnO), gallium oxide (Ga₂O₃), and a complex oxide containing these substances. FIGS. 5 and 6 illustrate hollow fine particle 20 having a spherical outer shape. As illustrated in FIG. 5, hollow fine particle 20 has a hollow structure where hollow portion 21 is provided inside. The outer shape of hollow fine particle 20 is not necessarily limited to such a spherical shape. FIGS. 7 and 8 illustrate a hollow fine particle having a polyhedral outer shape, more specifically, hexahedral hollow fine particle 20. As illustrated in FIG. 8, hollow fine particle 20 has a hollow structure where hollow portion 21 is provided inside. The outer shape of hollow fine particle 20 is not necessarily limited to such a hexahedral shape but may be other polyhedral shapes such as octahedron. The solvent is, for example, an alcohol-based solvent, a glycol-based solvent, or an aqueous solvent.

The shape can be confirmed by the SEM. The “spherical shape” does not necessarily represent a geometrically strictly spherical shape but a shape that can be visually recognized as an almost spherical shape through the observation of a SEM image. Similarly, the “polyhedral shape” represents a shape that can be visually recognized as an almost polyhedral shape through the observation of a SEM image.

According to this exemplary embodiment, average particle diameter d₂ of hollow fine particles 20 is at least 10 nm to at most 120 nm, and the largest particle diameter thereof is at most 400 nm. As illustrated in FIG. 6, the particle size of hollow fine particle 20 having a spherical shape is an outer diameter of hollow fine particle 20. To define the particle size of hollow fine particle 20 having a polyhedral shape, an inscribed sphere diameter is used. The particle diameter values are measured by the SEM apparatus. The visible light transmissivity of the front plate deteriorates as the largest particle diameter of hollow fine particles 20 has a greater value. As far as the largest particle diameter of hollow fine particles 20 is at most 400 nm which is equal to the shortest wavelength of visible light, the visible light transmissivity is certainly at least 75%. As far as the particle diameters of hollow fine particles 20 are at most 100 nm which is equal to the ¼ wavelength of the shortest wavelength of visible light, light diffusion between hollow fine particles 20 can be controlled. Therefore, average particle diameter d₂ of hollow fine particles 20 is more preferably at most 100 nm.

Hollow fine particles 20 preferably have a space factor equal to or larger than 10%-equal to or smaller than 60%. The space factor below 10% results in a higher dielectric constant. The space factor larger than 60% makes walls of hollow fine particles 20 thinner, making it difficult to ensure any desirable shape of hollow fine particles 20. The volume of hollow portion 21, which is an internal space of hollow fine particle 20, is divided by the volume of hollow fine particle 20, and a value thereby obtained represents the space factor.

Hollow fine particles 20 are produced by an organic particle plating technique or an inorganic particle plating technique. According to the organic particle plating technique, a target oxide is selectively deposited around organic core particles made of, for example, polystyrene by means of surface electric charges, and the organic core particles are removed after the surfaces of the organic core particles are coated with the oxide. According to the inorganic particle plating technique, core particles made of, for example, calcium carbonate are coated with a target oxide, and the inorganic core particles are dissolved to be removed after the surfaces of the inorganic core particles are coated with the oxide.

Whether the organic particle plating technique or inorganic particle plating technique is employed, the particle diameters and the space factor of hollow fine particles 20 rely on the particle diameters of the organic core particles or the inorganic core particles and the film thickness of the coating oxide. Specifically, the particle diameters and the space factor of hollow fine particles 20 can be controlled when the grain size distribution of the organic core particles or inorganic core particles stays within a given numeral range and the oxide film thickness stays within a given numeral range. Hollow fine particle slurry 40 may additionally include a lubricant or a dispersant because hollow fine particle slurry 40 additionally including a lubricant or a dispersant has better dispersibility.

3-1-3. Dielectric Paste 50

As described so far, dielectric glass slurry 30 and hollow fine particle slurry 40 are separately produced. Before front glass substrate 3 is coated with dielectric paste 50, dielectric glass slurry 30 and hollow fine particle slurry 40 are mixed and dispersed. A binder component such as a vehicle is further mixed and dispersed in dielectric paste 50, if necessary. The binder component includes ethyl cellulose or acrylic resin by 1 wt. %-20 wt. %. The binder component further includes terpineol or butyl carbitol acetate. Further, dioctyl phthalate, dibutyl phthalate, triphenyl phosphate, or tributyl phosphate may be added to the dielectric paste as a plasticizer. The binder component may be selected suitably for the solvent and used when the glass particles are ground, although the timing of mixing and dispersing the binder component is not necessarily limited thereto.

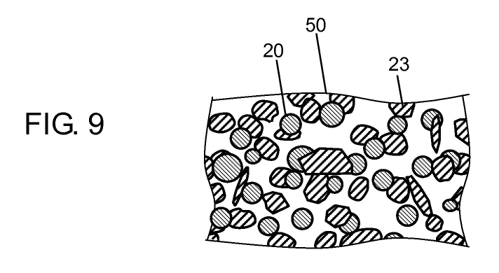

As illustrated in FIG. 9, the production method of dielectric paste 50 according to this exemplary embodiment can uniformly disperse dielectric glass fine particles 23 and hollow fine particles 20 in dielectric paste 50.

Given that the volume of dielectric glass per unit volume of dielectric layer 8 is V₁ and the volume of hollow fine particles 20 per unit volume of dielectric layer 8 is V₂, a contained amount of hollow fine particles 20 in dielectric layer 8 preferably fulfills equation 1 below.

$$0.1 \leq \frac{{V}_{2}}{{V}_{1} + {V}_{2}} \leq 0.74 \qquad ( Equation 1 )$$

In other words, the contained amount of hollow fine particles 20 is preferably at least 10 vol. % to at most 74 vol. %. In the case where hollow fine particles 20 are contained by below 10 vol. %, it becomes difficult to reduce the dielectric constant of dielectric layer 8. In the case where hollow fine particles 20 are contained by more than 74 vol. %, dielectric layer 8 has a lower density, resulting in a poor mechanical strength, meaning that cracks are more likely to occur in dielectric layer 8. To guarantee that dielectric layer 8 has an enough mechanical strength, hollow fine particles 20 are preferably included therein by at most 50 vol. %.

Further, a preferable numeral range of ratio d₂/d₁ between average particle diameter d₁ of dielectric glass fine particles 23 and average particle diameter d₂ of hollow fine particles 20 in dielectric paste 50 is calculated as described below. Given that the number of dielectric glass fine particles 23 per unit area of dielectric layer 8 is n₁ and the number of hollow fine particles 20 per unit area of dielectric layer 8 is n₂, the preferable numeral range is expressed by equation 2 below.

$$\frac{{V}_{2}}{{V}_{1}} = {( \frac{{d}_{2}}{{d}_{1}} )}^{3} \times \frac{{n}_{2}}{{n}_{1}} \qquad ( Equation 2 )$$

Then, the following equation 3 is derived from equations 1 and 2.

$$0.11 \leq {( \frac{{d}_{2}}{{d}_{1}} )}^{3} \times \frac{{n}_{2}}{{n}_{1}} \leq 2.85 \qquad ( Equation 3 )$$

To ensure that dielectric layer 8 has an enough mechanical strength, it is desirable that n₁>n₂ (Equation 4) be fulfilled. Unless equation 4 is fulfilled, it fails to adequately bond hollow fine particles 20 using glass, consequently deteriorating the mechanical strength of dielectric layer 8.

Further, equation 5 below is fulfilled because d₁ and d₂ are respectively at least 10 nm to at most 120 nm.

$$0.08 \leq \frac{{d}_{2}}{{d}_{1}} \leq 12 \qquad ( Equation 5 )$$

Given that equations 3 and 5 are both fulfilled and n₁/n₂≈1 is met, the condition of the average particle diameter ratio is defined by equation 6 below.

$$0.48 \leq \frac{{d}_{2}}{{d}_{1}} \leq 12 \qquad ( Equation 6 )$$

The right side of equation 6 is determined based on a largest value defined by equation 5. The left side of equation 6 is determined based on a smallest value defined by equation 3.

To include hollow fine particles 20 in dielectric layer 8 by a volume percentage within a given numeral range, it is preferable that hollow fine particles 20 be included in dielectric paste 50 by a volume percentage within a given numeral range. In other words, dielectric glass slurry 30 and hollow fine particle slurry 40 are mixed with each other based on the defined ratio. Alternatively, the contained amount of hollow fine particles 20 in hollow fine particle slurry 40 may be arranged to stay within a given numeral range during the production of hollow fine particle slurry 40.

3-2. Formation Method of Dielectric Layer 8

Dielectric layer 8 is formed by, for example, screen printing or die coating. First, dielectric paste 50 is applied on front glass substrate 3. The coating thickness of the dielectric paste layer thus obtained is suitably setup with a firing-caused shrinkage taken into account. The dielectric paste layer is dried in the temperature range of 100° C. to 200° C., preferably in the temperature range of 450° C. to 600° C., and more preferably in the temperature range of 550° C. to 590° C. As a result of the steps described so far, dielectric layer 8 including hollow fine particles 20 and dielectric glass layer 22 is formed.

The following method can be employed to form dielectric layer 8. First, a sheet obtained by spreading and drying dielectric paste 50 on a film is prepared. The dielectric paste formed on the sheet is transferred to front glass substrate 3 and then fired in the temperature range of 450° C. to 600° C., or preferably in the temperature range of 550° C. to 590° C. As a result of the steps described so far, dielectric layer 8 including hollow fine particles 20 and dielectric glass layer 22 is formed.

The luminance of PDP 1 improves as dielectric layer 8 has a smaller film thickness, and the discharge voltage of PDP 1 reduces as dielectric layer 8 has a smaller film thickness. Therefore, the film thickness of dielectric layer 8 is preferably smaller to such an extent that does not deteriorate the breakdown voltage. According to this exemplary embodiment, the film thickness of dielectric layer 8 is preferably at least 10 μm to at most 41 μm in view of the dielectric voltage and the visible light transmissivity both.

4. Summary

Dielectric paste 50 according to this exemplary embodiment, which is a glass paste for a plasma display panel, includes at least dielectric glass fine particles 23 and hollow fine particles 20. Dielectric glass fine particle 23 has a spherical shape or a scaly shape. Average particle diameter d₁ of dielectric glass fine particles 23 is at most 120 nm, and the largest particle diameter thereof is at most 400 nm. Average particle diameter d₂ of hollow fine particles 20 is at most 120 nm, and the largest particle diameter thereof is at most 400 nm.

PDP 1 according to this exemplary embodiment is a PDP obtained by using dielectric paste 50. Hollow fine particles 20 are preferably contained in dielectric layer 8 by at least 10 vol. % to at most 74 vol. %. In the case where hollow fine particles 20 are contained by below 10 vol. %, it becomes difficult to reduce the dielectric constant of dielectric layer 8. On the other hand, in the case where hollow fine particles 20 are contained by more than 74 vol. %, dielectric layer 8 has a lower density, resulting in a poor mechanical strength. This means that cracks are more likely to occur in dielectric layer 8.

PDP 1 according to this exemplary embodiment has front plate 2 and rear plate 10. Front plate 2 and rear plate 10 are disposed facing each other. Front plate 2 includes display electrodes 6 and dielectric layer 8 formed to cover display electrodes 6. Dielectric layer 8 includes hollow fine particles 20 having a hollowed-out inside. Dielectric layer 8 may include hollow fine particles 20 and dielectric glass layer 22 which is a glass layer. Hollow fine particles 20 are dispersed in dielectric layer 8.

With this configuration, dielectric glass layer 22 can ensure a binding strength between hollow fine particles 20. Hollow fine particle 20 has a hollowed-out inside, therefore, the dielectric constant inside of hollow fine particle 20 is approximately 1.0. As a result, the dielectric constant of hollow fine particle 20 per se has a value close to 1.0, thereby reducing the dielectric constant of dielectric layer 8.

The ratio d₂/d₁ between average particle diameter d₁ of dielectric glass fine particles 23 and average particle diameter d₂ of hollow fine particles 20 in dielectric paste 50 is preferably at least 0.48 to at most 12 because the ratio in the numeral range results in an improvement of the mechanical strength of dielectric layer 8.

A part of hollow fine particles 20 uniformly dispersed in dielectric layer 8 may be cracked. That is, fragments of hollow fine particles 20 may be scattered in dielectric layer 8. Because the glass does not enter hollow fine particles 20 partly cracked and opened, the hollow portions therein are sustained. Therefore, an operational effect is substantially equal whether a part of hollow fine particles 20 are cracked or uncracked. Even if the fragments of cracked hollow fine particles 20 enter the gaps between the dielectric glass fine particles, the film becomes more dense, thereby achieving a better film strength.

As time passes after dielectric paste 50 is applied, hollow fine particles 20 having a smaller specific gravity than the dielectric paste transfer toward the surface side of the dielectric paste layer. When front glass substrate 3 is dried in this state, a gradient in the thickness direction of dielectric layer 8 is generated in the volume of hollow fine particles 20 included therein. That is, the refractive index of dielectric layer 8 is not adversely influenced by such a gradient in the thickness direction of dielectric layer 8. The refractive index is relatively high as hollow fine particles 20 included in dielectric layer 8 on the side of front glass substrate 3 are lessened, whereas the refractive index is relatively low as hollow fine particles 20 included in dielectric layer 8 on the surface side are increased. With this configuration, there is a smaller interfacial refractivity difference between front glass substrate 3 and dielectric layer 8. Further, there is a smaller interfacial refractivity difference between dielectric layer 8 and the discharge space where the discharge gas is enclosed. Therefore, an interfacial reflectivity between front glass substrate 3 and dielectric layer 8 is reduced, and an interfacial reflectivity between the discharge space and dielectric layer 8 is reduced. As a result, the light emission can be more efficiently extracted, while an external light reflectivity is reduced.

Dielectric layer 8 may include hollow fine particles 20 and dielectric glass fine particles 23 which are glass fine particles. Dielectric layer 8 may include hollow fine particles 20, dielectric glass fine particles 23, and dielectric glass layer 22.

5. Evaluation of Working Example

A PDP was produced for a performance assessment test. The PDP thus produced is applicable to a 42-inch high vision television. PDP 1 has front plate 2 and rear plate 10 disposed facing front plate 2. The peripheral portions of front plate 2 and rear plate 10 are sealed to each other.

Discharge space 16 is formed between front plate 2 and rear plate 10. Front plate 2 includes display electrodes 6 and dielectric layer 8 formed to cover display electrodes 6. Dielectric layer 8 includes hollow fine particles 20. Front plate 2 further includes protective layer 9 provided to coat dielectric layer 8. Rear plate 10 has address electrodes 12, insulating layer 13, barrier ribs 14, and phosphor layers 15. An Ne—Xe-based mixed gas containing Xe by 15 vol. % is enclosed in discharge space 16 under the internal pressure of 60 kPa. An inter-electrode distance between display electrodes 6 is 0.06 mm. The barrier ribs 14 are formed to the height of 0.15 mm, and an interval between barrier ribs 14 (cell pitch) is 0.15 mm.

Hollow fine particle slurry 40 used then contained hollow fine particles 20 produced by the inorganic particle plating technique (principal constituent: SiO₂, space factor: 50%, average particle diameter: 100 nm, largest particle diameter: 200 nm, shape: sphere). Dielectric glass slurry 30 used then contained dielectric glass fine particles 23 produced by the described method (dielectric constant: 6.0, average particle diameter: 100 nm, largest particle diameter: 200 nm). Immediately before applying dielectric paste 50, hollow fine particle slurry 40 and dielectric glass slurry 30 were mixed with each other. Dielectric paste 50 was applied to front glass substrate 3 by die coating. The film thickness of the coating film thus formed was setup so that the post-firing film thickness of dielectric layer 8 was 15 μm. The firing was performed at a temperature equal to or higher than the softening point of dielectric glass fine particles 23. Therefore, dielectric layer 8 included hollow fine particles 20 and dielectric glass layer 22. Hollow fine particles 20 were contained in dielectric layer 8 by 20 vol. %. The dielectric constant of dielectric layer 8 was 4.0. The dielectric constant was measured by an LCR meter. The dielectric constant measured then was a value at the frequency of 1 kHz.

Thus, the visible light transmissivity of the substrate where dielectric layer 8 is formed on front glass substrate 3 was 80%. In other words, it is known from working example 1 that hollow fine particles 20 were uniformly dispersed in dielectric layer 8. There was no dielectric breakdown of dielectric layer 8, proving that dielectric layer 8 had an expected mechanical strength. Further, power consumption in PDP 1 of the working example was cut down by 10% as compared to any PDPs having a conventional dielectric layer.

The haze value of dielectric layer 8 according to the working example was 30%. The haze value was measured by a haze/transmissivity meter “HM-150” (supplied by MURAKAMI COLOR RESEARCH LABORATORY CO. Ltd.). The working example measured the light transmissivity (visible light transmissivity) and the haze value when single-wavelength light having the wavelength of 550 nm was made incident on the front glass substrate where the dielectric layer was formed from a direction orthogonal to the front glass substrate. It is known from the haze value thus measured that hollow fine particles 20 were uniformly dispersed in dielectric layer 8 according to the working example.

### INDUSTRIAL APPLICABILITY

As described above, the technique disclosed in the exemplary embodiment is useful in realization of a PDP with high-resolution display performance and low power consumption.

### REFERENCE MARKS IN THE DRAWINGS

1 PDP
2 front plate
3 front glass substrate
4 scan electrode
4a, 5a black electrode
4b, 5b white electrode
5 sustain electrode
6 display electrode
7 black stripe (light shielding layer)
8 dielectric layer
9 protective layer
10 rear plate
11 rear glass substrate
12 address electrode
13 insulating layer
14 barrier rib
15 phosphor layer
16 discharge space
20 hollow fine particle
21 hollow portion
22 dielectric glass layer
23 dielectric glass fine particle
24, 26 solvent
30 dielectric glass slurry
40 hollow fine particle slurry
50 dielectric paste
231 dielectric glass fine particle having a spherical shape
232 dielectric glass fine particle having a scaly shape

1. A glass paste for a plasma display panel, comprising at least dielectric glass fine particles and hollow fine particles, wherein
the dielectric glass fine particles have a spherical shape or a scaly shape,
an average particle diameter d₁ of the dielectric glass fine particles is at most 120 nm and a largest particle diameter thereof is at most 400 nm, and
an average particle diameter d₂ of the hollow fine particles is at most 120 nm and a largest particle diameter thereof is at most 400 nm.

2. The glass paste for a plasma display panel of claim 1, wherein a ratio d₂/d₁ between the average particle diameter d₁ of the dielectric glass fine particles and the average particle diameter d₂ of the hollow fine particles is at least 0.48 to at most 12.

3. A plasma display panel, wherein the glass paste for a plasma display panel as defined in claim 1 is used to form a dielectric layer, and
a content of the hollow fine particles in the dielectric layer is at least 10 vol. % to at most 74 vol. %.

4. A plasma display panel, wherein the glass paste for a plasma display panel as defined in claim 2 is used to form a dielectric layer, and
a content of the hollow fine particles in the dielectric layer is at least 10 vol. % to at most 74 vol. %.
